(19) United States
(12) Patent Application Publication
(10) Pub. No.: US 2014/0085443 A1
(43) Pub. Date: Mar. 27, 2014

(54) METHOD AND APPARATUS FOR ASSOCIATING EVENT INFORMATION WITH CAPTURED MEDIA

(71) Applicants: Sailesh Kumar Sathish, Tampere (FI); Igor Danilo Diego Curcio, Tampere (FI)

(72) Inventors: Sailesh Kumar Sathish, Tampere (FI); Igor Danilo Diego Curcio, Tampere (FI)

(73) Assignee: Nokia Corporation, Espoo (FI)

(21) Appl. No.: 13/627,723

(22) Filed: Sep. 26, 2012

(51) Int. Cl. H04N 7/18

(52) U.S. Cl. 348/61; 348/E07.085

(57) ABSTRACT

An approach is provided for associating relevant metadata and heuristics with one or more media segments of an even. An event analysis platform processes context information associated with one or more media capture devices to determine at least one event type. The event analysis platform further determines one or more event objects, one or more event heuristics, or a combination thereof based, at least in part, on the at least one event type. The event analysis platform associates the one or more event objects, the one or more event heuristics, or a combination thereof with one or more media segments captured by the one or more media capture devices.

### BACKGROUND

Service providers and device manufacturers (e.g., wireless, cellular, etc.) are continually challenged to deliver value and convenience to consumers by, for example, providing compelling network services. Important differentiators in the industry are application and network services that offer entertainment (e.g., media) and location services. In particular, media sharing services allow for distribution of content to other users of the media sharing service. Traditionally, the content distributed on such media sharing services is uploaded by one or more users. Interesting transformations of the content can be utilized to improve user experience, including transforming individual media segments into an aggregate/final media compilation. Unfortunately, there is currently no means of associating relevant metadata and heuristics with one or more media segments of an event for supporting generation of a final media compilation

### SOME EXAMPLE EMBODIMENTS

Therefore, there is a need for an approach for associating relevant metadata and heuristics with one or more media segments of an event.

According to one embodiment, a method comprises processing and/or facilitating a processing of context information associated with one or more media capture devices to determine at least one event type. The method also comprises determining one or more event objects, one or more event heuristics, or a combination thereof based, at least in part, on the at least one event type. The method further comprises causing, at least in part, an association of the one or more event objects, the one or more event heuristics, or a combination thereof with one or more media segments captured by the one or more media capture devices.

According to another embodiment, an apparatus comprises at least one processor, and at least one memory including computer program code, the at least one memory and the computer program code configured to, with the at least one processor, cause, at least in part, the apparatus to process and/or facilitate a processing of context information associated with one or more media capture devices to determine at least one event type. The apparatus is also caused to determine one or more event objects, one or more event heuristics, or a combination thereof based, at least in part, on the at least one event type. The apparatus further causes, at least in part, an association of the one or more event objects, the one or more event heuristics, or a combination thereof with one or more media segments captured by the one or more media capture devices.

According to another embodiment, a computer-readable storage medium carries one or more sequences of one or more instructions which, when executed by one or more processors, cause, at least in part, an apparatus to process and/or facilitate a processing of context information associated with one or more media capture devices to determine at least one event type. The apparatus is also caused to determine one or more event objects, one or more event heuristics, or a combination thereof based, at least in part, on the at least one event type. The apparatus further causes, at least in part, an association of the one or more event objects, the one or more event heuristics, or a combination thereof with one or more media segments captured by the one or more media capture devices.

According to another embodiment, an apparatus comprises means for processing and/or facilitating a processing of context information associated with one or more media capture devices to determine at least one event type. The apparatus also comprises determining one or more event objects, one or more event heuristics, or a combination thereof based, at least in part, on the at least one event type. The apparatus further comprises means for causing, at least in part, an association of the one or more event objects, the one or more event heuristics, or a combination thereof with one or more media segments captured by the one or more media capture devices.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 43-46.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of associating relevant metadata and heuristics with one or more media segments of an event, according to one embodiment;

FIG. 2 is a diagram of the components of an event analysis platform, according to one embodiment;

FIGS. 3A-3F are flowcharts of processes for associating relevant metadata and heuristics with one or more media segments of an event, according to various embodiments;

FIG. 4A is a diagram of media being captured of an event from different perspectives by different media capture devices, according to one embodiment;

FIGS. 4B-4D are diagrams of a user interfaces for presenting event information in connection an event, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for associating relevant metadata and heuristics with one or more media segments are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

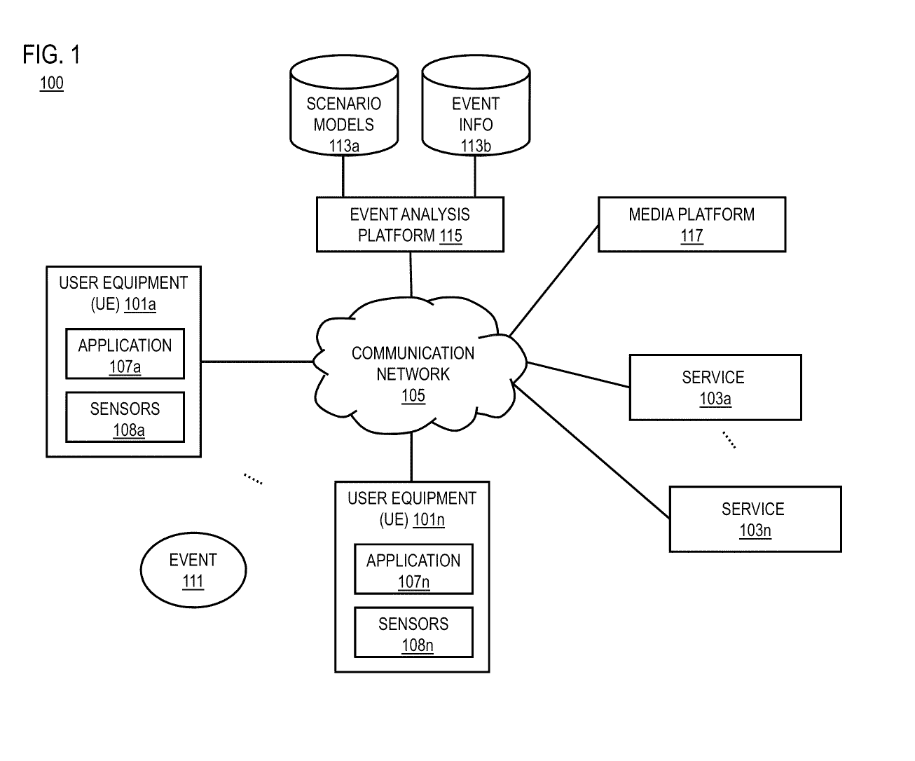

FIG. 1 is a diagram of a system capable of associating relevant metadata and heuristics with one or more media segments of an event, according to one embodiment. The metadata may include, for example, information for conveying an event type, an object associated with the event (i.e., an event object) or other information for describing the event. In addition, the metadata may include or be associated with, for example, criteria, statistics, semantics, rules or other heuristics associated with a determined event type. In certain embodiments, an event analysis platform 115 operates in connection with one or more media capture devices, i.e., a mobile device, internet ready camera or other user equipment (UE) 101a-101n to generate such information.

As noted above, an increasing number of devices, services and applications are targeted at providing social services and distributing media captured by individual users. As such, advances in mobile multimedia technology have given rise to an increase in user generated content. For example, most mobile devices on the market today feature integrated cameras and/or video recording sensors and accompanying applications for enabling on demand capture of media. Users can then readily share the content with others using one or more platforms (e.g., via the Internet) or other means.

Individual users commonly record media (e.g., video, audio, images, etc.) at events of interest. The type of events to be recorded may include, for example, concerts, festivals, sports outings, lectures, etc. As the events commence, the users employ their respective media capturing devices (e.g., a mobile phone, a camcorder, a digital camera, etc.) to record the event from different angles, perspectives or zoom factors. Consequently, objects of different types featured during the event (e.g., people, vehicles, a stage, a sports field) serve as the focal point of a given media segment at a given time of media capture. This variety of perspectives and instances of the event and/or objects thereof make for a more in-depth, albeit disconnected media viewing experience. The collection of different media segments may be made available for viewing by respective users by uploading them to a media sharing site, a social networking site or distribution via email or other communication means.

A more advantageous way to view such content would be to automatically enhance or customize media to generate a synthesized or machine-generated compilation, or transformation, of the collection of gathered media segments. Under this scenario, the captured media segments are uploaded (e.g., via a stream or file transfer) to a platform for generating the transformation. By way of example, a transformation pertains to any means of arranging, compiling and/or editing a collection of individual media segments to formulate a continuous media segment (e.g., a final video cut). The final continuous media segment is an amalgamation of the individual media segments, each of which pertain to the same event, for depicting various aspects, features and moments over a duration of time. It is noted, therefore, that the synthesized compilation (transformation) is generated automatically or otherwise without need for user intervention

Nonetheless, many technical challenges are present in generating such a synthesized compilation, especially in terms of categorizing and organizing the various media segments of the same event. For example, it can be challenging to determine which events or sub-events conveyed in one or more distinct media segments to focus upon when generating the transformation. Short of process intensive object and/or image recognition techniques, there is currently no convenient means of determining which objects featured in the one or more media segments correlate with a specific event type. Also, there is currently no means of associating the one or more media segments with specific rules, criteria or event scenarios for optimizing the media transformation process.

To address this problem, a system 100 of FIG. 1 introduces the capability to associate media segments captured by different user equipment (UE) 101a-101n with contextually, semantically, and/or heuristically relevant metadata for use in subsequent processing of the one or more media segments. Under this scenario, the captured media segments pertain to a common event 111 and may be processed in connection with or based on the metadata for enabling automated production of a final media compilation. By way of example, the system 100 includes an event analysis platform 115, which operates in connection with a media production, media generation or other tool/platform 117 for generating the final compilation. In addition, the event analysis platform 115 interact with UE 101a-101n to facilitate the gathering of information on behalf of, or in conjunction with, the media platform 117.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

The UE 101a-101n may be positioned at different locations relative to the location/occurrence of the event 111 for capturing media segments or for focusing upon one or more objects during an event 111. In certain embodiments, the UEs 101a-101n serve as media capture devices for acquiring, via sensors 108a-108n photos, video clips, audio clips, etc., pertaining to an event 111. The UEs 101a-101n trigger execution of the event analysis platform 115, such as when an application 107a-107n for capturing media is initiated. In response, the media capture application 107a-107n transmits context information related to the image capture devices and/or the one or more event objects to be featured as media to a media platform 117 via a communication network 105. In certain embodiments, the related information may be analyzed to determine information about the existence of the event 111. Also, for the purpose of illustration, the media platform 117 may be synonymous with a media application (e.g., application 107a-107n) accessible by calling UE 101a-101n.

By way of example, the context information may include location information of the media capture device, temporal information corresponding to the moment of capture of media pertaining to an event, or a combination thereof. Moreover, information regarding the media capture devices or event objects in view such as speed information, movement information, tilt information, position information or the like may also be conveyed to the event analysis platform 115. Still further, image information such as zoom data, panning data, screen orientation data, focal point data, resolution data and the like may also be conveyed in connection with a captured media segment.

It is noted that sensors 108a-108n collect information pertaining to the movement of an event object and/or the response of the UE 101a-101n relative to said event object at the time of the event 111. For example, a sensor of the UE 101a-101n may determine a relative speed of a vehicle as it traverses a given distance as viewed from the perspective of the UE 101a-101n. This determination may be based, at least in part, on a multitude of factors, including a relative rate of movement of the media capture device as the vehicle (event object) is in motion, a relative zoom rate applied for capture of the vehicle (event object) relative to the location of the media capture device, etc. The related information may be processed by the event analysis platform 115 to ascertain details about the event in lieu of performing object, image or video recognition of said media segments.

In certain embodiments, the event analysis platform 115 processes the context information to determine an event type that is related to the media segments. For example, location information and temporal information may be processed against event information 113b maintained by the platform 115 or by one or more accessible services (103a-103n) to determine a probable matching event taking place at that time. The location information may be determined based on the processing of global positioning system (GPS) coordinates, wireless local area networking (WLAN) identification, Bluetooth identification, cell tower identification or the like. Furthermore, event type identification may be based on cross-checking by the event analysis platform 115 of the location information against map information, place type information, event registration information and the like. Of note, the services 103a-103n may be established to interact with the event analysis platform 115 for maintaining the event information 113b or the event information may be maintained directly by the event analysis platform 115.

In certain embodiments, the event types may include descriptors or data fields for defining the location, the name of a given location or event, a particular activity, scene or moment associated with a given location or event, a type of venue or name thereof, a type of situational scenario or the like. Also, the event type may correspond to information for providing details about the event, including scheduling information, building and/or room information, host and/or sponsor information, event admission information or the like. It is noted, therefore, that the structure of metadata presented for indicating the event type and associated event information is based on the various data fields required to be populated. As will be further discussed, the event analysis platform 115 requests user specified entry the various data fields and hence required event type and information as needed.

If upon analysis of the context information a match is determined between the context information and available event information 113b, the analysis platform 115 sends the event type information to the requesting UE 101a-101n. Once received, the UE 101a-101n then displays the event type and associated event data (per the various data fields) along with one or more user acknowledgement requests. Under this scenario, for example, when the user is participating in an educational event (e.g., a lecture), event type information rendered to the UE 101a-101n by the platform 115 may include:

Event type: Lecture
Event information: Signal Processing Lecture by Professor Marsh

### Event Location Tech University

By way of example, the event type, event information and event location represent various data fields that define and/or characterize the event. In certain embodiments, the event analysis platform 115 may define a more granular subset of data fields accordingly.

The user acknowledgement request may include an acknowledgement action of YES or NO being indicated by the user—i.e., via selection of associated action buttons. The acknowledgement may be received by the event analysis platform 115, per input at the UE 101a-101n, for indicating accuracy of the event type and/or associated event information. In the case where the event type and associated information are acknowledged (e.g., a YES action button is selected from a user interface of the UE 101a-101n), the event analysis platform 115 then determines one or more event objects, one or more event heuristics, or a combination thereof to be associated with the event type. This information is maintained by the event analysis platform 115 as one or more scenario models 113a. Of note, the associated heuristics and event object information are then loaded as metadata in association with the media to be recorded.

As noted previously, the event heuristics may include one or more criteria, semantic identifiers or rules for specifying event objects associated with an event type, one or more data fields to be populated in association with the at least one event type and/or one or more rules for creating a compilation of the one or more media segments. By way of example, in the case of the event type being determined to be a baseball game, the heuristics may specify a baseball bat and a baseball as typical related event objects. In addition, motion types and speed information may be specified as heuristics for defining a typical path or behavior of said event objects. In addition, the heuristics may include data for specifying the relative or expected position and orientation of players associated with a baseball event. For example, players (event objects) may be defined as corresponding to a diamond orientation at defined distances away from one another.

The scenario models 113a may also indicate various statistics/heuristics for defining the one or more event objects and/or associated characteristics or behaviors thereof. For example, in the case of the baseball event type, averages for defining the typical speed of a pitch or rate of running of a player to a base position may be determined. Still further, a typical decibel level associated with fans at the baseball game along with an average duration of an inning may be specified. It is noted that while the above described example pertains to event objects capable of motion, the heuristics may also define characteristics of one or more inanimate event objects. This may include, for example, a dugout, a mascot or other object related to baseball. The heuristics define features, structures and/or patterns associated with said objects directly or indirectly such that event objects featured in media can be identified without costly, process intensive object recognition techniques.

The above scenario pertains to an instance wherein the event analysis platform 115 is able to readily correlate the event 111 with the available event information 113b. In certain embodiments, when there is no event information 113b associated with the context information of the UE 101a-101n, the event analysis platform 115 transmits a list of probable event types that may be associated with that location or location type. The suggestions are based on an order of decreasing probability of event types. For example, in the case of the event 111 corresponding to a lecture occurring at a university, the event analysis platform 115 determines various activities, locations or venues that correspond to the university for the current time of day. Under this scenario, the event type list may indicate, in the following order: (a) Cafeteria (e.g., request was received around lunch time), (b) Lecture, (c) Meeting or (d) Sports Outing. It is noted that the probability, and hence order, is based on the best known location information associated with the UE 101a-101n at the time of occurrence, historical event type information corresponding to said location and time, or a combination thereof.

Once rendered to the display of UE 101a-101n, the user then chooses the correct event type from the list, which in this example is option (b). The selection is made by way of input provided to a user interface of the UE 101a-101n specifying the selection of the Lecture event type (e.g., touch input). The event analysis platform 115 then receives notification of this selection and determines scenario models 113a corresponding to said selection. As such, the event analysis platform 115 is able to associate one or more event objects and heuristics with the event type. Also, per the selection, the event analysis platform 115 causes the UE 101a-101n to load structures/heuristics related to the Lecture event type for use in defining the media (e.g., video) to be captured during the event 111.

Per the above described scenario, the event information is used as additional information and user feedback is provided to the event analysis platform 115. For example, the event analysis platform 115 may adapt the probability ranking of events to associate with the lecture event type after N number of users of UE 101 at the event confirms the event type. Based on the previous example, this causes the lecture event type to be presented as option (a), while the other suggested event types descend within the list. It is noted that the platform 115 ensures persistent updating of event probability information based on the refinement of location data as well as confidence scores/selections of users associated with the same event type. It is further contemplated that the event analysis platform 115 may maintain a log of such feedback and confidence scoring for subsequent use in generating suggested event types in the absence of event information 113b.

In certain embodiments, the event analysis platform 115 also enables event related media to be associated with key metadata and heuristics in instance where no reliable location information and event information can be identified. Under this scenario, the event analysis platform 115 causes the rendering of a notification message to the UE 101a-101 that no event information is available. The event analysis platform 115 then requests that the client user manually provide information regarding the location. This may include enabling the selection of a number of location types, categories or sub-categories, such as Universities, Restaurants, Zip Codes, etc. The location type information enables the event analysis platform 115 to refine its location determination capabilities in response to a request from a corresponding media capture device (e.g., UE 101). As such, the event analysis platform 115 generates a list of probable event types that correspond to the user indicated location type. Under this scenario, the user of the requesting UE 101 selects a location type from the list and the event analysis platform 115 is notified accordingly. It is noted, in certain instances, that the location type may be equivalent to the event type or may depict a broader/less refined description or associated category/hierarchy of event types. For example, an event location may correspond to the name of a university (e.g., Tech University) while a location type may pertain to a general category (e.g., University).

In response, the event analysis platform 115 creates a new entry within its database 113b for associating the location information specified by the user of UE 101 with the specified location type. Alternatively, the event analysis platform 115 notifies a corresponding service 103a-103b of the association, wherein the service creates an entry via its respective databases accordingly. For example, with reference again to the lecture event type, a set of location coordinates gathered via sensors 108a-108b of a given UE 101a-101n will be mapped to the specified location type of University. As a result, all further requests from other UE 101 for the same location will be associated with the University location type as a first probable event type to which a media capture request corresponds. This probability is refined once N users of UE, also configured to interact with the platform 115, have acknowledged the event.

It is noted that even after selection of an event and/or location type, the suggested event type list may still be presented to the display of the UE 101a-101n. By way of example, the list may be rendered to the display of a UE 101 in a less prominent position of the user interface or made to be activated for viewing at the discretion of a user. In this way, if the currently selected location type and/or event type conveyed by the event analysis platform 115 is inaccurate or incomplete; the user may further refine the selection. This corresponds to a refining of the event information 113b by the event analysis platform 115 accordingly.

For the above described executions, the event type and associated event information for a plurality of users of respective devices UE 101a-101n is synchronized. Hence, in the case of three different media capture devices (e.g., UE 101a-101c) being employed to record a common event 111, each would display the same corresponding event information. In addition, adaptations in the order of presentment of suggested event types and/or location types are dynamically reflected across the displays of all of the UE 101a-101n in response to a user selection or change thereof. Still further, as a result of the synchronization, as media is captured during the event 111 (e.g., the lecture) each of the respective UE 101a-101c associate the same metadata and heuristic information with their respective captured media segments. By way of this approach, the event analysis platform 115 is able to present the independently captured media segments of the event 111 to a media platform 117 in an efficient, contextually consistent manner for supporting generation of a final synthesized compilation of the media. Also, the media platform 117 may process the metadata and associated heuristics for ensuring automated generation of the final compilation in accordance with one or more predefined user preferences (e.g., a preference for more scenes featuring the lecturer or whiteboard versus scenes featuring students attending the lecture).

In certain embodiments, as the UE 101a-101n continuously upload (streams) of metadata, the event analysis platform 115 processes the information (in aggregate) in real time to determine event objects present in the media segment that match the scenario models (e.g., heuristics 113a) for that event type. In addition to this processing, the event analysis platform 115 may also acquire initial user location data with respect to the determined event, i.e., via a mapping service 103. Under this approach, a map may be shown in connection with the event type or other event information depending on the type of event location. Still further, ancillary documents and notes related to an event 111 may be further acquired by the event analysis platform 115 based on the determined event type and associated heuristics. For example, in the case of a lecture event type, a multimedia slide show related to the subject matter of the lecture may be associated with captured media segments of the event. As such, segments of the multimedia slideshow may be processed by the media platform 117 in accordance with the event type and heuristic data for generating a final media compilation.

In certain embodiments, the event analysis platform 115 performs aggregated analysis of location and position information as received from the plurality of UE 101a-101n configured to the platform 115. As noted, this analysis enables the platform 115 to confirm that it has determined one or more event objects associated with an event based on the feedback and/or response of a number of users. By way of example, the event analysis platform 115 analyzes orientation data that is streamed continuously from UE 101a-101n during the event 111. Each stream is analyzed to identify orientation data for an object with respect to the position of the streaming UE 101. Since the position of each UE 101 can be determined to some degree of certainty, the event analysis platform 115 is further able to determine the direction a given UE 101 is pointing by analyzing UE 101 orientation angles (e.g., as provided by a magnetometer sensor). Per this approach, the coordinate spaces for all the orientation angles are unified and intersection points from multiple views (different streams) of the event 111 are determined. It is noted that the intersection points correspond to a focal point of respective UE 101a-101n as they focus on capturing one or more event objects.

Also, each intersection has a timestamp, such that the stream of data (e.g., context information) for respective UE 101 is sent to the event analysis platform 115 in near real-time. The timestamp enables the platform 115 to determine a moment in time wherein an event object was focused upon by a particular UE 101 from its respective orientation/position. In certain embodiments, the event analysis platform 115 maintains a record of the number of users of UE 101a-101n associated with a common event and attempt to confirm their positions/orientations relative to specific event objects. By way of example, when N number of UE 101a-101n are determines, the event analysis platform 115 may prompt a number of said UE 101 to seek a specific event object. If enough users are determined to adapt their orientation and intersect the same event object, the event analysis platform 115 is able to fix the position for that event object with respect to the location map. Under this scenario, therefore, the position of a podium within a lecture event is confirmed due to the response of a number of individual users of UE 101a-101n. It is noted that this approach accounts for known probability factors and heuristics, such that higher probability event objects (e.g., a whiteboard in the case of a lecture event type) are sought to be associated with the event type prior to lower probability event objects (e.g., a podium in the case of a lecture event type).

In certain embodiments, the event analysis platform 115 may query another subset of the group of users of UE 101a-101n to seek confirmation of other event objects determined to be associated with a given event type (e.g., based on probability and/or heuristics). By way of this approach, the event analysis platform 115 may confirm the location of each event object defined (per the heuristics) for the event 111. This enables adaptations in orientation of certain UE 101a-101n relative to a given event object to be accounted for accordingly. In addition, changes in movement, position and/or orientation of certain event objects themselves (e.g., movement of a lecturer about the lecture room) may be accounted for by the event analysis platform 115. Of note, detecting the relative position of one event object may also enable the event analysis platform 115 to predict and/or identify a common intersection point or location of another related event object. For example, in the case of a football event type, the location of the end zone area may also provide a relative orientation and position for a goal post. Also of note, the platform 115 may receive feedback from the user of additional event objects not initially defined per the heuristic for the event type. As such, the event analysis platform 115 may receive input from the user for enabling refinement of the scenario models for the event type or for the specific event in question.

Once the various event objects are determined (confirmed), the event analysis platform 115 is able to notify the user of the specific event object being sensed by their respective UE 101a-101n during event capture. For example, in the case where the user is in the lecture room, the event analysis platform 115 may render a message to the display of the UE 101 for indicating “Now Viewing: Podium” or “Now Viewing: Dr. Katon.” As this occurs, the timestamp associated with that event object is associated with the captured media stream; thus enabling the event analysis platform 115 to relay to the media platform 117 contextually relevant information in association with the media stream.

It is noted that the output generated by the event analysis platform 115 is conveyed to the media platform 117 for supporting generation of a final media compilation. This may include, for example, conveyance of the output to the media applications 107a-107n of respective UE 101a-101n for use in capturing one or more media segments. By way of example, per the above described operations, the output rendered by the event analysis platform 115 may include: (1) contextually rich data pertaining to one or more captured media segments and/or one or more media streams; (2) data for specifying the event objects that are present within the one or more media segments and/or media streams at a particular point of time (e.g., embedded within the segment or stream); (3) data for indicating a relative orientation, position, location and intersection data for the event 111 and/or specific objects thereof; (4) metadata for indicating the number of different perspectives and/or views captured for the event and/or specific objects thereof; (5) data for indicating the number of UE 101a-101n associated with a given event 111 and/or with the one or more captured media segments; and (6) data for indicating how specific media segments were captured including zoom data, panning data, screen orientation data, focal point data, resolution data; (7) heuristics associated with the event 111 or objects thereof; and the like. In certain embodiments, this information is embedded within a media segment as metadata. For example, the data may be stored in one or more data structures or forms, such as RDF/XML (Resource Description Framework/Extensible Markup Language). It is contemplated, however, that this data may alternatively be provided as meta-information in conjunction with the captured media segments and/or media streams without being stored.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

By way of example, the UEs 101, event analysis platform 115 and media platform(s) 117, communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the UE 101 and event analysis platform 103 interact according to a client-server model. Per this model, a client process sends a message including a request to a server process and the server process responds by providing a service. The server process may also return a message with a response to the client process. Often the client process and server process execute on different computer devices, called hosts, and communicate via a network using one or more protocols for network communications. The term “server” (e.g., the platform 115) is conventionally used to refer to the process that provides the service, or the host computer on which the process operates. Similarly, the term “client” (e.g., the UE 101) is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. It is noted that while shown as separate entities, the event analysis platform 115 may be integrated within the media platform 117 accordingly.

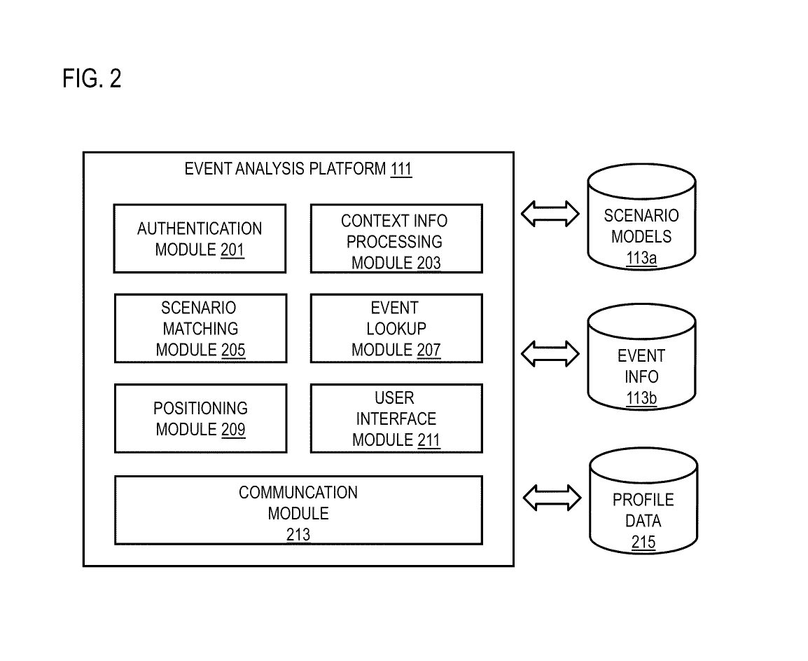

FIG. 2 is a diagram of the components of the event analysis platform 115 according to one embodiment. By way of example, the event analysis platform 115 includes one or more components for associating relevant metadata and heuristics with one or more media segments of an event. It is contemplated that the functions of these components may be combined in one or more components or performed by other components of equivalent functionality. In this embodiment, the event analysis platform 115 includes an authentication module 201, a context information processing module 203, a scenario matching module 205, an event lookup module 207, a positioning module 209, a user interface module 211 and a communication interface 211.

In one embodiment, an authentication module 201 authenticates users and user devices 101a-101n for interaction with the event analysis platform 115. By way of example, the authentication module 201 receives a request from a UE 101 to process context information associated with the UE 101 during or in preparing for capture of an event 111. This request may be signaled by activation of an application 107, such as a media capture application, at the UE 101. The request may include, for example, passage of information for identifying the user of the UE 101 or device information pertaining to the UE 101. Under this approach, the authentication module 201 may receive an IP address, a carrier detection signal of a user device, mobile directory number (MDN), subscriber identity module (SIM) (e.g., of a SIM card), radio frequency identifier (RFID) tag or other identifier for recognizing the requesting user and/or UE 101. It is noted that user and/or device data may be cross-referenced against profile data 215 maintained by the event analysis platform 115 for enabling validation of a given UE 101 for interaction with the event analysis platform 115.

In one embodiment, the context information processing module 203 processes context information gathered by the sensors 108a-108n of respective UE 101a-101n. The processing includes analyzing the context information 113 to determine the relative location, time, position, etc., of UE 101 for capturing media related to an event. By way of example, the context information processing module 203 can determine a location of a UE 101 based on a triangulation system such as a GPS, assisted GPS (A-GPS) A-GPS, Cell of Origin, wireless local area network triangulation, or other location extrapolation technologies. In addition, standard GPS and A-GPS systems can use satellites to pinpoint the location (e.g., longitude, latitude, and altitude) of the UE 101. A Cell of Origin system can also be used to determine the cellular tower that a cellular UE 101 is synchronized with. This information provides a coarse location of the UE 101 because the cellular tower can have a unique cellular identifier (cell-ID) that can be geographically mapped.

In addition, the context information processing module 203 can be utilized to determine a range between the UE 101 and an object. The range detection can further be guided to determine how far an object centered by the UE 101 is. By way of this approach, the module 203 can be used to detect that an event object is in view and whether the view includes one or more obstructions to an event 111. Still further, the module 203 can determine the direction of a UE 101, i.e., horizontal directional data as obtained from a magnetometer (sensor) or angular offset or tilt as determined by a gyroscope (sensor). Speed and/or acceleration data may also be determined along with rotational rate information of the UE 101 about a particular reference point corresponding to the UE 101 location. It is noted that the context information processing module 203 may operate in connection with the positioning module 209 for performing analysis of the context information with respect to multiple UE 101 determined to be related to a common event 111.

Once the context information is processed, the module 203 then triggers execution of the event lookup module 207, which determines whether the context information pertains to any known (e.g., registered) event information 113b. This may include querying the event information database 113b to identify an event that best matches the location of the UE 101 at the time of the request. Alternatively, the event lookup module 207 may be configured to interact with one or more services (e.g., 103a-103n), such as a social networking service or event registration service, for performing the query. It is noted also that the event lookup module 207 may generate an entry in the event information database 113b or at a particular service 103 in cases where no existing event information is associated with a particular location.

In certain embodiments, the scenario matching module 205 matches the event type determined by the event lookup module 207 and context information processing module 203 to identify one or more scenario models 113a related to the event. The scenario models 113a may include various heuristics for specifying certain characteristics of the event type, one or more event objects typically associated with the event type, various statistics or probability factors, etc. The scenario matching module 205 associates the scenario models with the one or more media segments to which the context information was related. It is noted that the module 205 may be configured to embed the event type and other related event information to the one or more corresponding media segments as metadata conforming to a defined data structure.

In one embodiment, the positioning module 209 and user interface module 211 interact to facilitate the tracking, gathering and confirming of various event objects in response to a request from a media capture application of the UE 101. By way of example, the positioning module 209 generates a signal for additional information regarding an event. This may include, for example, initiating a querying/polling of one or more UE 101 to confirm a position, orientation, intersection, or a combination thereof of one or more event objects related to an event. In addition, the positioning module 209 may cause the adapting of a list of suggested event types based on analysis of an aggregate or predetermined number N of UE 101 interacting with the event analysis platform 115. The adapted list is transmitted to the UE 101, via a communication interface, by the user interface module 211 at the request of the positioning module 209.

Still further, the positioning module 209 may trigger generation and transmission of a confirmation request to the one or more UE 101a-101n in connection with an event. This includes requesting a capture or focus of one or more UE 101 upon a particular event object then monitoring the response. Under this scenario, the positioning module 209 receives context information for the plurality of UE 101 that responds to the confirmation request then confirms a particular event type and/or event object based on said response. The confirmation may include, for example, determining a correlation between individual media segments conveyed by respective UE 101a-101n based on relative positions, orientations and the like along with timestamp information for said segments.

It is noted that the positioning module 209 and context information processing module 203 generate various output information, such as in the form of metadata, for being associated with one or more media segments. This may include, for example, context information, heuristic information, data for specifying the event objects and their respective elevations, orientations, etc., image related data such as zoom data, panning data, screen orientation data, focal point data, resolution data, and any other information for indicating a response or relationship between one or more event objects and one or more UE 101 capturing media featuring said event objects.

In one embodiment the user interface module 211 enables the generation of a user interface or one or more graphical user interface elements for conveying information to a user of UE 101a-101n. By way of example, the user interface module 215 generates the interface in response to application programming interfaces (APIs) or other function calls corresponding to the media application 107, thus enabling the display of graphics primitives. This may include, for example, displaying of event type, event information and event location data in response to current capturing of an image of an event. In addition, the user interface module 211 may be triggered for execution by the positioning module 209 to facilitate transmission of event object confirmation requests and the like.

In one embodiment, a communication module 213 enables formation of a session over a network 105 between the event analysis platform 115 and the application 107. By way of example, the communication module 213 executes various protocols and data sharing techniques for enabling collaborative execution. It is noted that the communication module 213 may also enable the transmission of any output generated by the event analysis platform to the media platform 117 for use in generating a final media compilation. This includes output (processing results) generated by the positioning module 209 or context information processing module 203.

The above presented modules and components of the event analysis platform 115 can be implemented in hardware, firmware, software, or a combination thereof. For example, although the event analysis platform 115 is depicted as a separate entity or as a platform or hosted solution in FIG. 1, it is contemplated that it may be implemented for direct operation by respective UEs 101a-101n. As such, the event analysis platform 115 may generate direct signal inputs by way of the operating system of the UE 101 for interacting with the application 107 and for capturing media per an event 111. Alternatively, some of the executions of the above described components may be performed at the UE 101a-101n while others are performed offline or remotely per a client server interaction model between the UE 101a-101n and the platform 115.

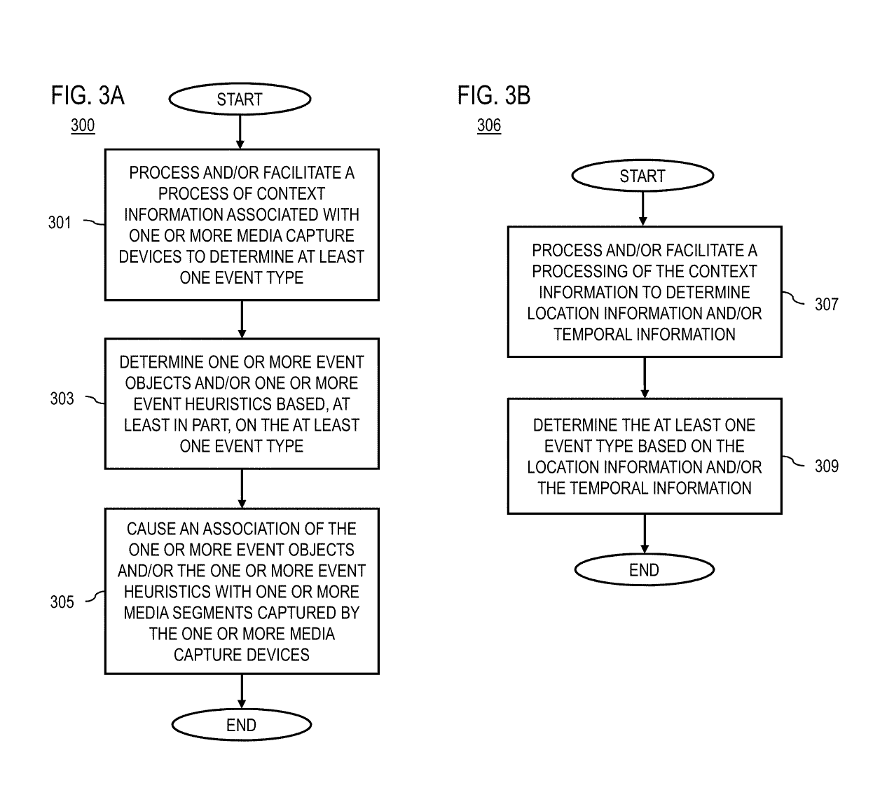

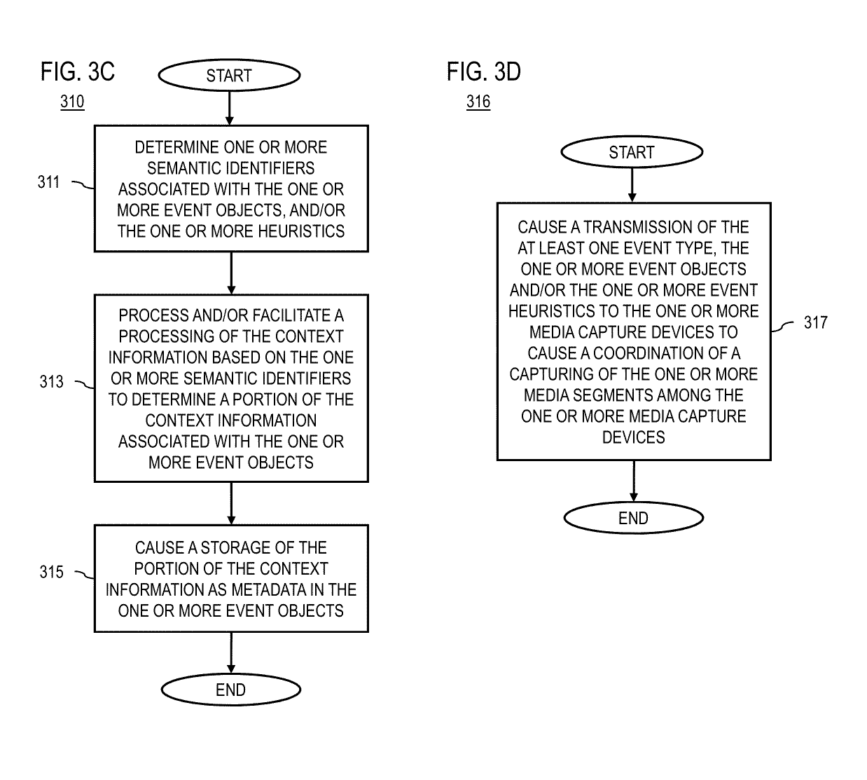

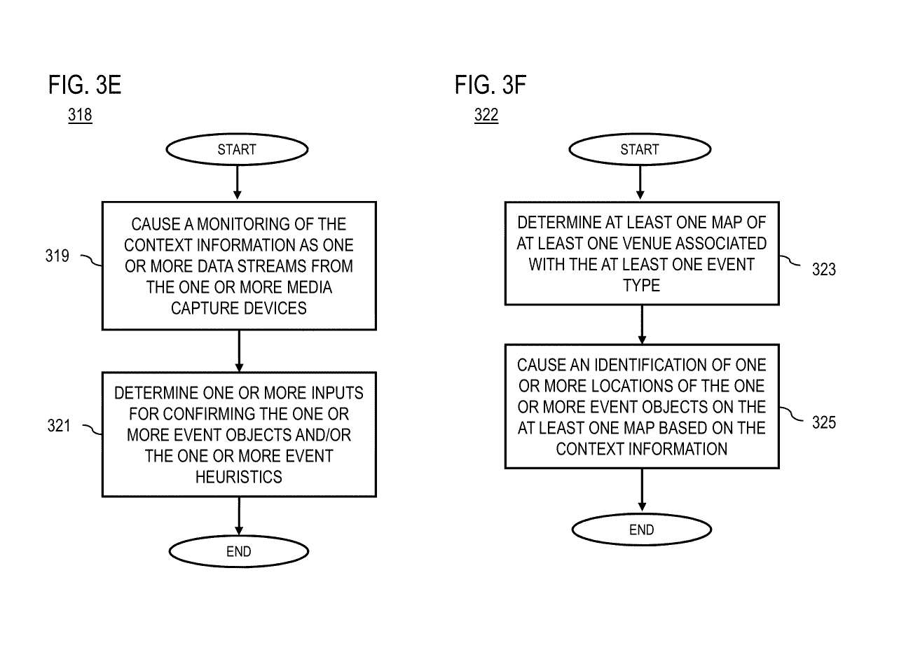

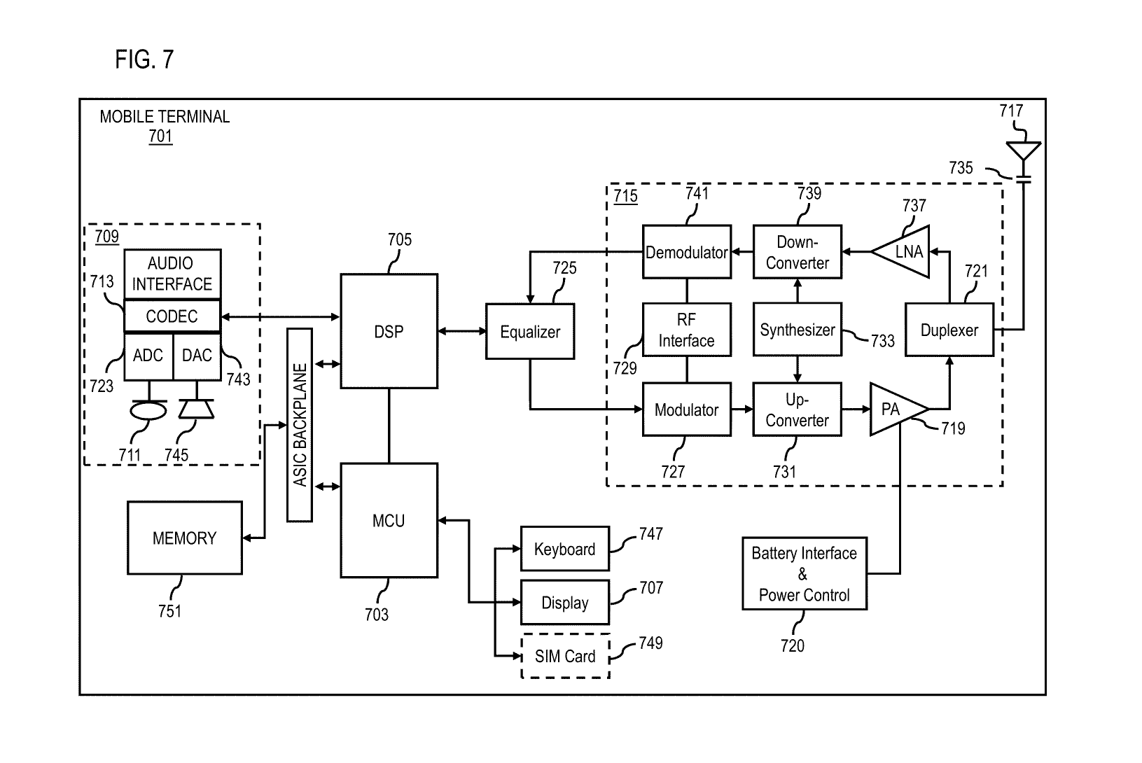

FIGS. 3A-3F are flowcharts of processes for associating relevant metadata and heuristics with one or more media segments of an event, according to various embodiments. In one embodiment, the event analysis platform 115 performs processes 300, 306, 310, 316, 318 and 322 and is implemented in, for instance, a chip set including a processor and a memory as shown in FIG. 7.

At step 301, the event analysis platform 115 processes and/or facilitates a processing of context information associated with one or more media capture devices to determine at least one event type. In step 303, the platform 115 determines one or more event objects, one or more event heuristics, or a combination thereof based, at least in part, on the at least one event type. By way of example, the one or more event heuristics specify, at least in part, (a) the one or more event objects; (b) one or more data fields associated with the at least one event type to collect; (c) one or more rules for creating a compilation of the one or more media segments; or (d) a combination thereof. In step 305, the platform 115 causes an association of the one or more event objects and/or the one or more event heuristics with one or more media segments captured by the one or more media capture devices. This association enables optimized processing of the one or more media segments by a media platform 117 for generation of a final compilation.

In step 307 of process 306 (FIG. 3B), the event analysis platform 115 processes and/or facilitates a processing of the context information to determine location information and/or temporal information. In another step 309, the platform 115 determines the at least one event type based, at least in part, on the location information, the temporal information, or a combination thereof. As noted previously, this may include performing a query and/or cross referencing of the location and temporal information against a database of known event information. In certain embodiments, the event information may be that which is directly maintained per an event analysis registry database. Alternatively, the event information may be that maintained by one or more services accessible to the event analysis platform 115.

In step 311 of process 310 (FIG. 3C), the event analysis platform 115 determines one or more semantic identifiers associated with the one or more event objects and/or the one or more heuristics. By way of example, the semantic identifiers may include specific keywords featured in one or more media segments. In step 313, the platform 11 processes and/or facilitates a processing of the context information based on the one or more semantic identifiers to determine a portion of the context information associated with the one or more event objects. Per step 315, the platform 115 causes a storage of the portion of the context information as metadata in the one or more event objects. In certain embodiments, the media platform 117 may process the semantic identifiers based on the one or more heuristics for performing audio analysis of the media segments. This may include determining occurrences of silence areas, talking areas, music and other characteristics such as a downbeat in the case of music related event types. In another embodiment, semantic analysis is done by using a speech recognizer to detect keywords in the stream to generate media edits based on when in the stream such hot words are recognized.

Under this scenario, for example, a phrase spoken by a lecturer during a lecture event type of “now, as seen from the whiteboard . . . ” may be readily identified because of the semantic identifier “whiteboard.” As such, the segment of media featuring this audio reference will be associated with all media segments that feature the whiteboard during the lecture. As another example, for a sports event type, a semantic identifier of “touchdown” will enable the identification all media segments corresponding to the scoring of a touchdown. Hence, it is noted that the semantic identifiers may be used by the media platform 117 as a means of filtering and further organizing the one or more media segments.

In step 317 of process 316 (FIG. 3D), the event analysis platform 115 causes a transmission of the at least one event type, the one or more event objects and/or the one or more event heuristics to the one or more media capture devices to cause a coordination of a capturing of the one or more media segments among the one or more media capture devices. As noted previously, this may include conveyance of the output to the media platform 117 for generating a final media compilation.

In step 319 of process 318 (FIG. 3E), the event analysis platform 115 causes a monitoring of the context information as one or more data streams from the one or more media capture devices. By way of example, the determining of the one or more event objects, the one or more event heuristics, or a combination thereof is based, at least in part, on the monitoring. It is noted that the monitoring is performed concurrent with the acquiring of the data streams, which pertains to real-time capture of media pertaining to an event. In step 321, the platform 115 determines one or more inputs for confirming the one or more event objects and/or the one or more event heuristics. The inputs may include those provided by a user in response to a suggestion of one or more event types or a request for confirmation regarding one or more event objects.

In step 323 of process 322 (FIG. 3F), the event analysis platform 115 determines at least one map of at least one venue associated with the at least one event type. In step 325, the platform 115 causes an identification of one or more locations of the one or more event objects on the at least one map based on the context information. It is noted, in certain embodiments, that the map may be conveyed to a UE 101a-101n in connection with the event type. The map may also be stored for future reference with respect to the determined event type.

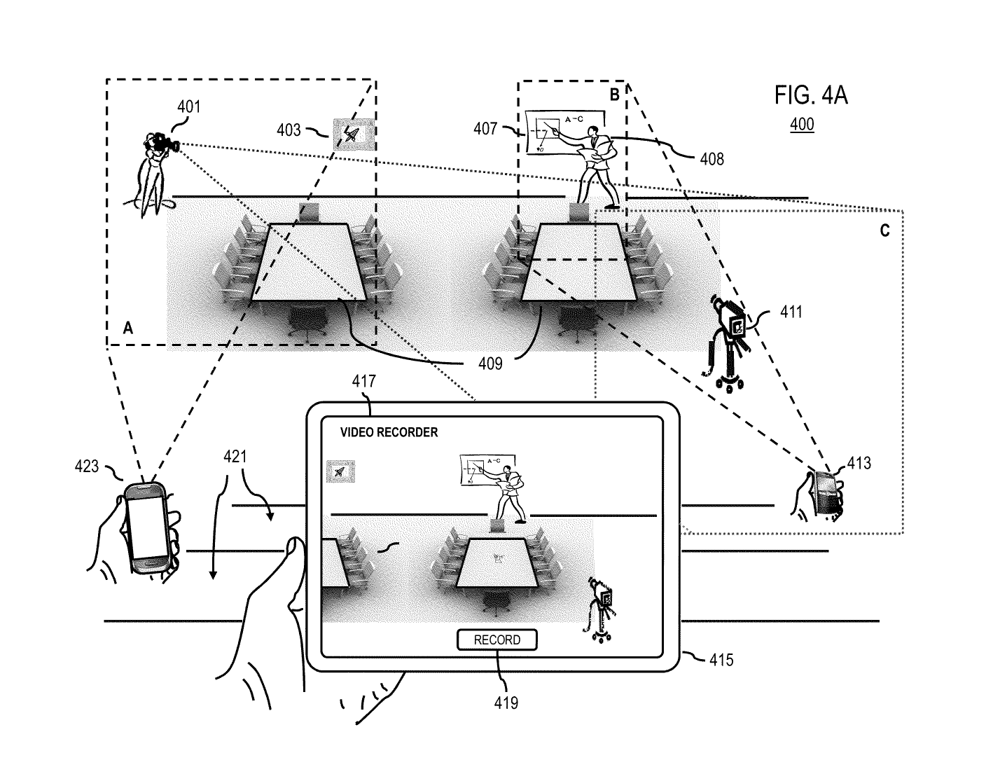

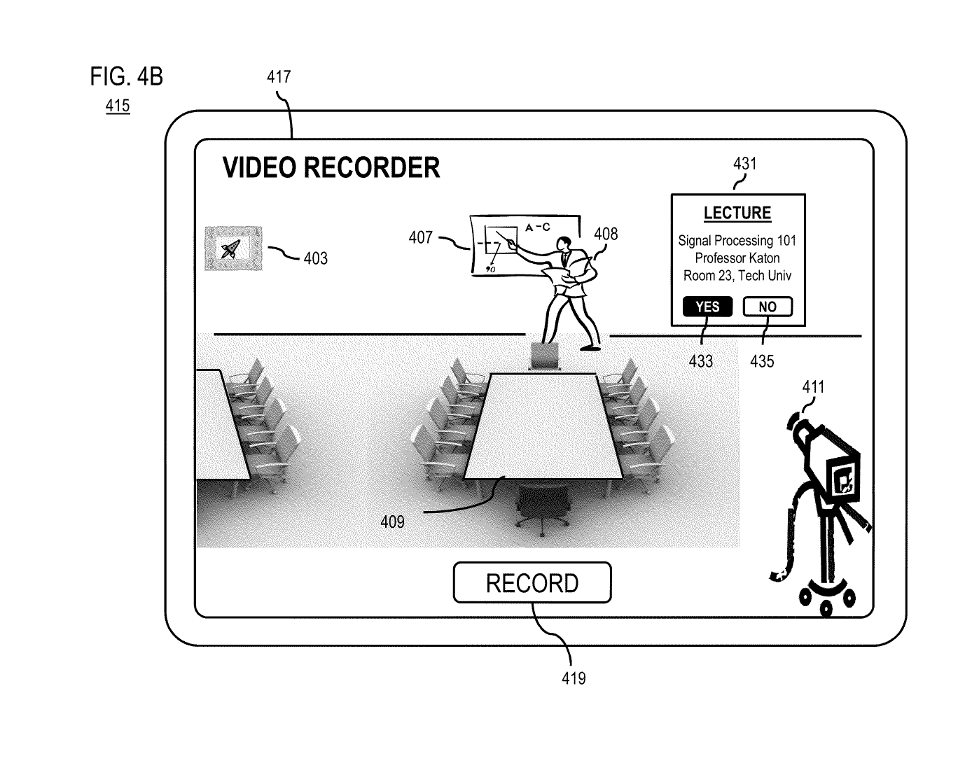

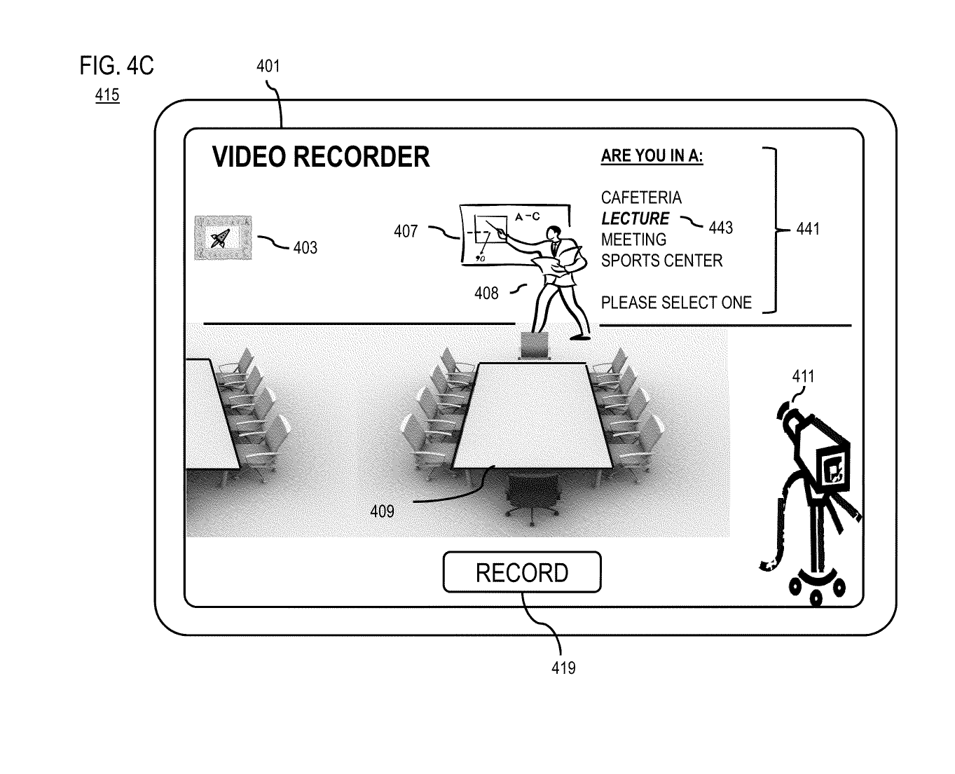

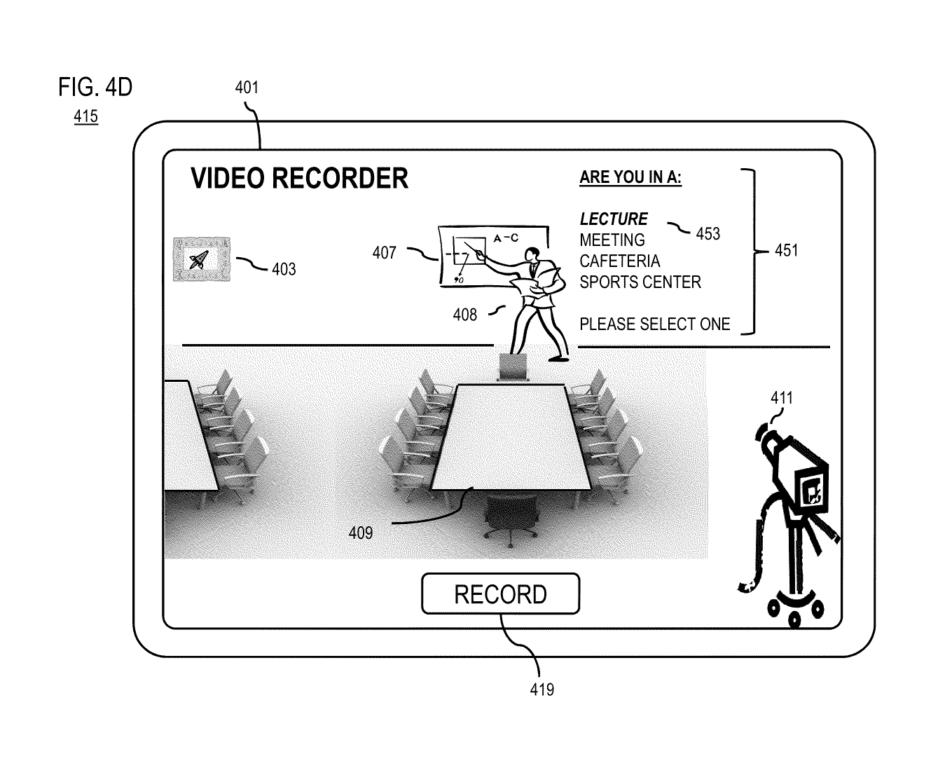

FIG. 4A is a diagram of media being captured of an event from different perspectives by different media capture devices, according to one embodiment. Also, FIGS. 4B-4D are diagrams of a user interfaces for presenting event information in connection with captured media of an event, according to various embodiments. For the purpose of illustration, the diagrams are described from the perspective of a use case of one or more users participating in a lecture event 400. The users capture (record) the event utilizing their respective media capture devices, which are configured to interact with the event analysis platform 115.

In FIG. 4A, several media capture devices 423 and 413 of students partaking in the lecture are active for capturing video of the event 400 at the present moment. In addition, a production camera device 401 is employed by a technician of the university for recording and transmitting the lecture as a live broadcast. Each media capture device 401, 413 and 423 record the lecture from different vantage points and perspectives, some of which intersect—i.e., capture overlapping event objects. Under this scenario, device 413 belonging to a first student seated towards the front right side of the lecture hall (e.g., per auditorium seating 421) captures video segment B. Video segment B features various event objects, including a whiteboard 407, a lecturer 408 and a conference table 409. Device 423 belonging to a second student seated towards the left of the auditorium seating in the middle row of the auditorium seating 421 captures video segment A. Video segment A features various event objects, including a conference table 409, a picture 403 and a manned video camera 401. Still further, device 401 of the technician captures video segment C, which features event objects 409, 411, the first student as they use their device 413 and the auditorium seating 421.

For this scenario, each of the above referenced devices 423, 413 and 401 have previously interacted with the event analysis platform 115 for enabling their respective video segments A-C to be correlated with specific event information. Hence, the event analysis platform 115 received context information pertaining to each media capture device 401, 413 and 423 to determine at least a location and temporal information pertaining to the devices. Based on this interaction, the event analysis platform 115 was able to determine the location and time corresponded to a lecture event type as registered via a university event database (accessible by the platform 115). In addition, heuristic information pertaining to the event type of lecture was determined, thus enabling various event objects (e.g., whiteboard 407, auditorium seating 421) to be recognized for enhancing the probability/accuracy of the event type. It is noted, for this example, the first student helped refine the heuristics for the captured event by associating the unique picture 403 with the specific location of the event. The prior interaction of the event analysis platform 115 with the devices for influencing the capture of media reflects a precedent, wherein existing event information and a log of event type determination for this location is available.

In keeping with the scenario, a device 415 belonging to a third student enters the lecture hall at a later time, i.e., subsequent to the initial interaction of the other devices 401, 413 and 423 with the event analysis platform 115. The third student decides to sit at the topmost row of the auditorium seating 421 towards the middle of the lecture hall. Resultantly, the perspective, including the tilt, location and available view for capture of the event for device 415 is different than that of the other devices. The interaction between the third student's device 415 and the event analysis platform 115 as the student attempts to record the event is presented in the foregoing paragraphs.

In FIG. 4B, the third student activates a media capture application of their device 415, which enables a view of a portion of the event 400 to be rendered to the display 417. The student selects the record button 419 to begin recording the view as shown. Alternatively, the user may refrain from selecting the record action button 419 as they position the device 415, adjust a zoom level of the device 415, alter the focal point, etc. In either case, the media application calls upon the sensors of the device 415 to collect context information regarding the device, including location information and temporal information. In addition, the sensors collect orientation data, tilt data, zoom data, etc. In certain embodiments, it is contemplated that a light detection sensor may also detect an intensity of ambient light within the lecture room. All of the context information is then sent to the event analysis platform 115 accordingly.

The event analysis platform 115 receives the context information, such as in the form of a processing request, from the device 415. Upon receipt, the event analysis platform 115 first attempts to identify if any existing or known event information can be identified based on the provided location and temporal information. In this case, given the precedent of numerous other devices (e.g., 401, 413 and 423) having already interacted with the event analysis platform 115 per the same relative location and time frame; the event analysis platform 115 determines the user is participating in the same event. The probability/accuracy of this determination is enhanced when the platform 115 analyzes the tilt data, orientation data and other data relative to heuristics for defining event objects (e.g., objects 403, 407, 409 and 411) within view of the device 415 against that acquired by the other devices 401, 413 and 423.

Consequently, the platform 415 causes the rendering of a notification message 431 to the display 417 for indicating the determined event information. This includes, for example, a specification that the event type is a “Lecture,” which is presented in bold underlined font. In addition, an event name is also presented as “Signal Processing 101.” The event host is also presented as “Professor Katon.” Finally, an event location is presented as “Room 23 of Tech University.” Action buttons 433 and 435 are also presented for enabling the user to acknowledge YES or NO respectively that the event information is correct. When the user selects the YES action button 433, the event information is associated with any video captured by the device 415 from thereon. Selection of the NO action button 435 causes the event analysis platform 115 to request additional information from the user for refining the determined event information. It is noted for this example, however, that the event information 431 is caused to be presented with a high level of confidence based on the precedent of interaction with the other devices 403, 413 and 423 for the same event type and location.

It is further noted that the event characteristics presented in the notification 431, namely event type, event name, event host and event location correspond to one or more data types/fields defined for the determined event type. The data types/fields as well as their corresponding structure may be defined, for example, per the heuristics for the event type. Under this scenario, the level of granularity of information for specifying these data types is based on the granularity of event information available for the event 400. For example, the event name and host is available only to the extent the event database maintains such information. In addition, the granularity is based on the current or prior feedback/responses of the other devices 403, 413 and 423 per their interaction with the platform 115. For example, prior interaction with the platform 115 by a number of devices enables certain event objects (e.g., the painting 403) to be uniquely associated with the determined location and/or venue. As such, the heuristic data for the event type of Lecture, and specifically the Signal Processing 101 lecture, may be refined as the aggregate contextual and/or user feedback (e.g., YES or NO acknowledgements) increase over time.

FIG. 4B pertains to a use case wherein event information and associated heuristics are readily determined for the device 415 based on the availability of event information and prior device interaction with the event analysis platform 115. Consequently, the event information 431 was rendered to the display of the device 415 without requiring significant user intervention. In FIG. 4C however, a use case is presented wherein no event information is available to the event analysis platform 115. Consequently, the event analysis platform 115 requires additional selection and/or confirmation from the user regarding the event type or event objects thereof to effectively associate an event type with captured video of the event 400.

Under this scenario, when the third student activates the media application, context information pertaining to the device 415 is transmitted to the event analysis platform 115. As noted previously, the context information is transmitted as a processing request via a communication network in the case of a hosted platform 115 solution, or initiated by way of an API call in the case of a local platform 115 implementation. In either event, the event analysis platform 115 processes the request and determines no matching event information for the current location of the device 415 at the time of request.

Resultantly, the event analysis platform 115 causes the rendering of a notification message 441 for specifying a list of probable event types 441 that may be associated with the location, which is determined to be Tech University. The suggestions are based on an order of decreasing probability of event types for that location (Tech University) or corresponding location type (e.g., a University). Under this scenario, the event type list is ordered as follows order: (a) Cafeteria (e.g., request was received around lunch time), (b) Lecture, (c) Meeting or (d) Sports Center.

Based on these options, the user then chooses the correct event type from the list, which in this example is the Lecture event type 443. In this example, the user provides a touch input for indicating the selection, which causes the Lecture event type 443 to be highlighted within the list. The event analysis platform 115 then receives notification of this selection and determines scenario models 113a that correspond to Lectures. As such, the event analysis platform 115 is able to associate one or more event objects and heuristics with the Lecture event type. Also, per the selection 443, the event analysis platform 115 loads the structures/heuristics related to the Lecture event type. As such, any video captured by the device 415 in relation to this event 400 is associated with the heuristics as well as present moment context information regarding the device 415.

In FIG. 4D, the suggested list of event types 451 is dynamically adapted based on additional feedback from other device users per the same event 400. For example, in the case where the first and second students select the Lecture event type during their initial interaction with the platform 115 (in the absence of event information), the event analysis platform 115 updates the list 441 of FIG. 4C to reflect the most popular/probable event type (e.g., list 451). Consequently, the Lecture event type 453 is featured at the top of the list, while the other event types are featured in descending order of probability thereafter. It is noted, therefore, that the event analysis platform 115 ensures synchronization of the event information between media capture devices.

The processes described herein for associating relevant metadata and heuristics with one or more media segments of an event may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

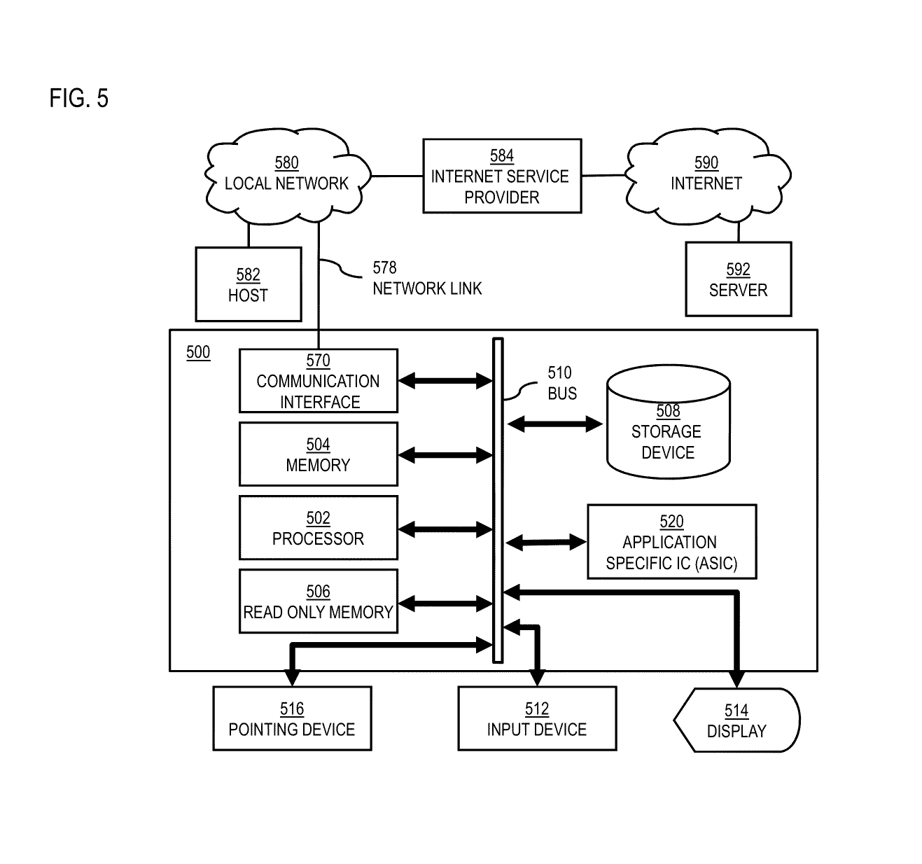

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to associate relevant metadata and heuristics with one or more media segments of an event as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of associating relevant metadata and heuristics with one or more media segments of an event.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to associate relevant metadata and heuristics with one or more media segments of an event. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for associating relevant metadata and heuristics with one or more media segments of an event. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for associating relevant metadata and heuristics with one or more media segments of an event, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for associating relevant metadata and heuristics with one or more media segments of an event to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

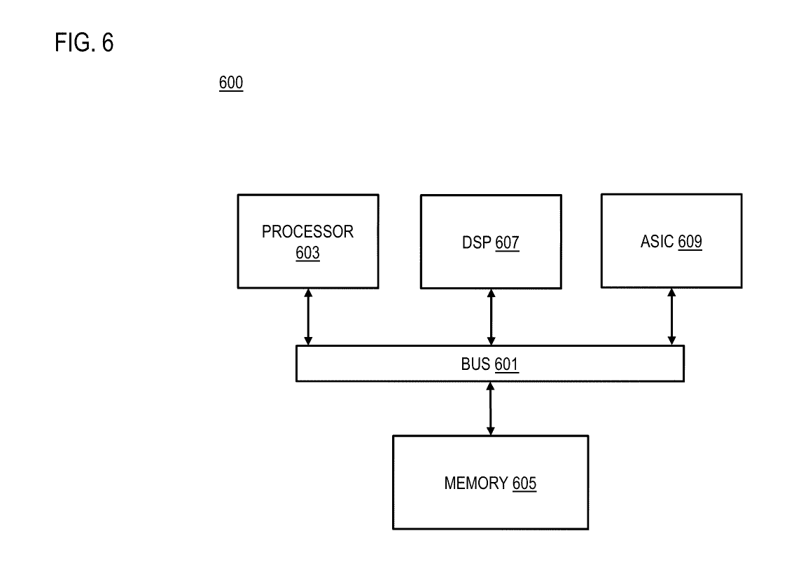

FIG. 6 illustrates a chip set or chip 600 upon which an embodiment of the invention may be implemented. Chip set 600 is programmed to associate relevant metadata and heuristics with one or more media segments of an event as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of associating relevant metadata and heuristics with one or more media segments of an event.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to associate relevant metadata and heuristics with one or more media segments of an event. The memory 605 also stores the data associated with or generated by the execution of the inventive steps.

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of associating relevant metadata and heuristics with one or more media segments of an event. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of associating relevant metadata and heuristics with one or more media segments of an event. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to associate relevant metadata and heuristics with one or more media segments of an event. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a processing of context information associated with one or more media capture devices to determine at least one event type;
at least one determination of one or more event objects, one or more event heuristics, or a combination thereof based, at least in part, on the at least one event type; and
an association of the one or more event objects, the one or more event heuristics, or a combination thereof with one or more media segments captured by the one or more media capture devices.

2. A method of claim 1, wherein the (1) data and/or (2) information and/or (3) at least one signal are further based, at least in part, on the following:
a processing of the context information to determine location information, temporal information, or a combination thereof; and
at least one determination of the at least one event type based, at least in part, on the location information, the temporal information, or a combination thereof.

3. A method of claim 1, wherein the (1) data and/or (2) information and/or (3) at least one signal are further based, at least in part, on the following:
one or more semantic identifiers associated with the one or more event objects, the one or more heuristics, or a combination thereof;
a processing of the context information based, at least in part, on the one or more semantic identifiers to determine a portion of the context information associated with the one or more event objects; and
a storage of the portion of the context information as metadata in the one or more event objects.

4. A method of claim 3, wherein the portion of the context information, the metadata, or a combination thereof describe, at least in part, one or more locations associated with the one or more event objects.

5. A method of claim 1, wherein the (1) data and/or (2) information and/or (3) at least one signal are further based, at least in part, on the following:
a transmission of the at least one event type, the one or more event objects, the one or more event heuristics, or a combination thereof to the one or more media capture devices to cause, at least in part, a coordination of a capturing of the one or more media segments among the one or more media capture devices.

6. A method of claim 1, wherein the one or more event heuristics specify, at least in part, (a) the one or more event objects; (b) one or more data fields associated with the at least one event type to collect; (c) one or more rules for creating a compilation of the one or more media segments; or (d) a combination thereof.

7. A method of claim 1, wherein the (1) data and/or (2) information and/or (3) at least one signal are further based, at least in part, on the following:
a monitoring of the context information as one or more data streams from the one or more media capture devices,
wherein the determining of the one or more event objects, the one or more event heuristics, or a combination thereof is based, at least in part, on the monitoring.

8. A method of claim 7, wherein the (1) data and/or (2) information and/or (3) at least one signal are further based, at least in part, on the following:
one or more inputs for confirming the one or more event objects, the one or more event heuristics, or a combination thereof.

9. A method of claim 1, wherein the (1) data and/or (2) information and/or (3) at least one signal are further based, at least in part, on the following:
at least one map of at least one venue associated with the at least one event type; and
an identification of one or more locations of the one or more event objects on the at least one map based, at least in part, on the context information.

10. A method of claim 1, wherein the at least one event type includes, at least in part, one or more hierarchies of the at least one event type and one or more other event types.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of context information associated with one or more media capture devices to determine at least one event type;
determine one or more event objects, one or more event heuristics, or a combination thereof based, at least in part, on the at least one event type; and
cause, at least in part, an association of the one or more event objects, the one or more event heuristics, or a combination thereof with one or more media segments captured by the one or more media capture devices.

12. An apparatus of claim 11, wherein the apparatus is further caused to:
process and/or facilitate a processing of the context information to determine location information, temporal information, or a combination thereof; and
determine the at least one event type based, at least in part, on the location information, the temporal information, or a combination thereof.

13. An apparatus of claim 11, wherein the apparatus is further caused to:
determine one or more semantic identifiers associated with the one or more event objects, the one or more heuristics, or a combination thereof;
process and/or facilitate a processing of the context information based, at least in part, on the one or more semantic identifiers to determine a portion of the context information associated with the one or more event objects; and
cause, at least in part, a storage of the portion of the context information as metadata in the one or more event objects.

14. An apparatus of claim 13, wherein the portion of the context information, the metadata, or a combination thereof describe, at least in part, one or more locations associated with the one or more event objects.

15. An apparatus of claim 11, wherein the apparatus is further caused to:
cause, at least in part, a transmission of the at least one event type, the one or more event objects, the one or more event heuristics, or a combination thereof to the one or more media capture devices to cause, at least in part, a coordination of a capturing of the one or more media segments among the one or more media capture devices.

16. An apparatus of claim 11, wherein the one or more event heuristics specify, at least in part, (a) the one or more event objects; (b) one or more data fields associated with the at least one event type to collect; (c) one or more rules for creating a compilation of the one or more media segments; or (d) a combination thereof.

17. An apparatus of claim 11, wherein the apparatus is further caused to:
cause, at least in part, a monitoring of the context information as one or more data streams from the one or more media capture devices,
wherein the determining of the one or more event objects, the one or more event heuristics, or a combination thereof is based, at least in part, on the monitoring.

18. An apparatus of claim 17, wherein the apparatus is further caused to:
determine one or more inputs for confirming the one or more event objects, the one or more event heuristics, or a combination thereof.

19. An apparatus of claim 11, wherein the apparatus is further caused to:
determine at least one map of at least one venue associated with the at least one event type; and
cause, at least in part, an identification of one or more locations of the one or more event objects on the at least one map based, at least in part, on the context information.

20. An apparatus of claim 11, wherein the at least one event type includes, at least in part, one or more hierarchies of the at least one event type and one or more other event types.

21-46. (canceled)
